(19) United States
(12) Patent Application Publication
(10) Pub. No.: US 2005/0088708 A1
(43) Pub. Date: Apr. 28, 2005

(54) Scan window assembly with an open boundary

(76) Inventors: Thomas Sheng, Hsinchu (TW); Ching-Jung Tu, Hsinchu City (TW)

Correspondence Address: BIRCH STEWART KOLASCH & BIRCH, PO BOX 747, FALLS CHURCH, VA, 22040-0747, US

(21) Appl. No.: 10/967,163

(22) Filed: Oct. 19, 2004

(30) Foreign Application Priority Data
Oct. 23, 2003 (TW) 092129476
Feb. 4, 2004 (TW) 093102552

(51) Int. Cl. H04N 1/04; B41J 11/14

(52) U.S. Cl. 358/487; 358/486

(57) ABSTRACT

A scan window assembly with an open boundary includes a hollow housing, a transparent platen, and a first positioning corner for positioning a document. The hollow housing contacts the transparent platen at first and second interfaces to seal an opening of the hollow housing. The first interface is formed by an internal surface of the hollow housing and a top surface of the transparent platen contacting the internal surface. The second interface is formed by an external surface of the hollow housing and a bottom surface of the transparent platen contacting the external surface. The second and first interfaces are positioned at different horizontal heights.

### BACKGROUND OF THE INVENTION

1. Field of the Invention

The invention relates to a scan window assembly with an open boundary, and more particularly to a scan window assembly, which has an open boundary and enables a document to be effectively and quickly placed, positioned, and taken out.

2. Description of the Related Art

The scanning size of the scanner has been gradually diversified according to the user's requirement. A scanner having a minimum scanning size of A3 size, and a scanner having a maximum scanning size of A6 size have been already available in the market. FIG. 1 is a pictorial view showing a conventional scan window assembly. Referring to FIG. 1, the scan window assembly includes a hollow housing 110, a transparent platen 120, and four sidewalls 110A to 110D and four positioning corners 141 to 144 formed between the hollow housing 110 and the transparent platen 120. A step is formed between a horizontal external surface 111 of the hollow housing 110 and the transparent platen 120. The four sidewalls 110A to 110D define a closed boundary of the transparent platen 120.

In the above-mentioned scan window assembly, the area of the scanned document is preferably smaller than the area enclosed by the closed boundary. In this case, it is possible to position a given corner of the document according to any one of the positioning corners 141 to 144. However, there is usually a default positioning corner, such as 141.

However, when the area of the document P is larger than the area enclosed by the closed boundary, the document P has to be located on the horizontal external surface 111 and the transparent platen 120 simultaneously, thereby causing different depths of focus. In addition, in this scan window assembly, it is not quite easy to place the document and take the document out, and the skill is required especially when the document is taken out. Usually, the user uses his/her fingers to pinch the document and the document tends to be damaged if the user does not pinch the document carefully.

Another method for positioning the document in the scan window assembly is made according to the width of the document as the reference for positioning the document, and some copiers adopt this positioning method. For example, the copier or scanner only provides a positioning boundary to position the document with a single side, and calibrations (e.g., up and down calibrations corresponding to the A4-size document) are drawn on the positioning boundary in order to position the other side of the document. This positioning method cannot provide a quick and precise positioning effect, and sometimes the image of the document cannot be correctly acquired owing to the user's inadvertence.

Hence, it is an important subject of the invention to provide a scan window assembly, which has an open boundary and enables a document to be effectively and quickly placed, positioned, and taken out.

### SUMMARY OF THE INVENTION

It is therefore an object of the invention to provide a scan window assembly, which has an open boundary and enables a document to be effectively and quickly placed, positioned, and taken out.

Another object of the invention is to provide a scan window assembly, which has an open boundary and enables a large-format document to be smoothly placed on the scan window assembly.

Still another object of the invention is to provide a scan window assembly, which has an open boundary and enables the user to scan a book conveniently.

The invention achieves the above-identified objects by providing a scan window assembly with an open boundary. The scan window assembly includes a hollow housing, a transparent platen and a positioning edge. The hollow housing has an external surface, an internal surface, and an opening penetrating through the hollow housing from the external surface to the internal surface. The transparent platen has a top surface and a bottom surface. The hollow housing contacts the transparent platen at a plurality of interfaces to seal the opening of the hollow housing. The interfaces include a first interface and a second interface. The first interface is formed by the internal surface of the hollow housing and the top surface of the transparent platen contacting the internal surface. The second interface is formed by the external surface of the hollow housing and the bottom surface of the transparent platen contacting the external surface. The second interface and the first interface are positioned at different horizontal heights. The positioning edge is formed by the transparent platen and the hollow housing to position a document placed on the transparent platen.

The hollow housing may further have a document supporting surface for supporting the document placed thereon. The document supporting surface is flush with the top surface of the transparent platen, and the document supporting surface is a portion of the external surface.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a pictorial view showing a conventional scan window assembly.

FIG. 2 is a pictorial view showing a scan window assembly according to a first embodiment of the invention.

FIG. 3 is a cross-sectional view showing the scan window assembly of FIG. 2.

FIG. 4 is a pictorial view showing a scan window assembly according to a second embodiment of the invention.

FIG. 5 is a cross-sectional view showing a scan window assembly according to a third embodiment of the invention.

FIG. 6 is a cross-sectional view showing a scan window assembly according to a fourth embodiment of the invention.

FIG. 7 is a cross-sectional view showing a scan window assembly according to a fifth embodiment of the invention.

FIG. 8 is a cross-sectional view showing a scan window assembly according to a sixth embodiment of the invention.

FIG. 9 is a cross-sectional view showing a scan window assembly according to a seventh embodiment of the invention.

FIG. 10 is a cross-sectional view showing a scan window assembly according to an eighth embodiment of the invention.

FIG. 11 is a cross-sectional view showing a scan window assembly according to a ninth embodiment of the invention.

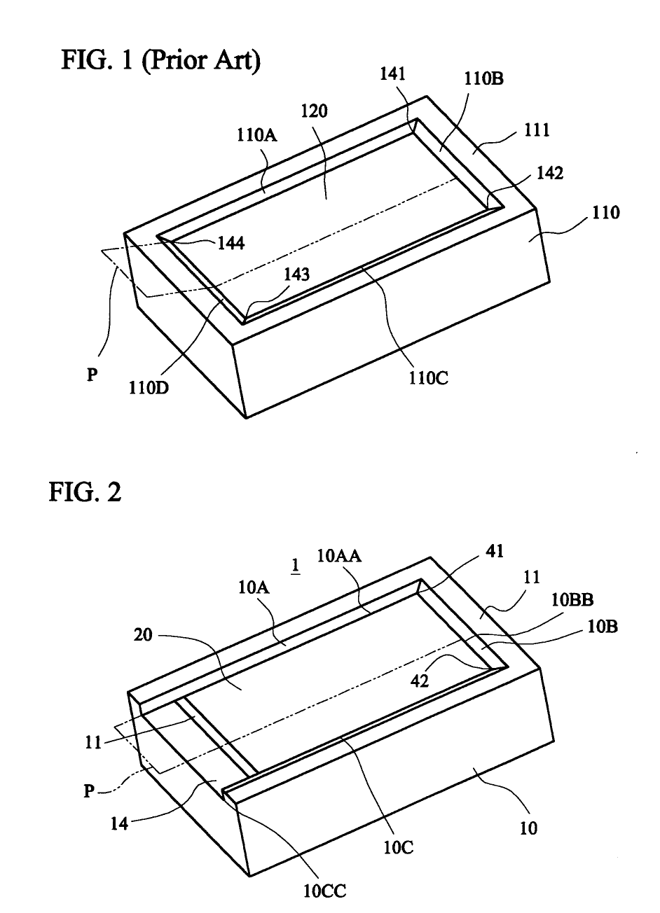

### DETAILED DESCRIPTION OF THE INVENTION

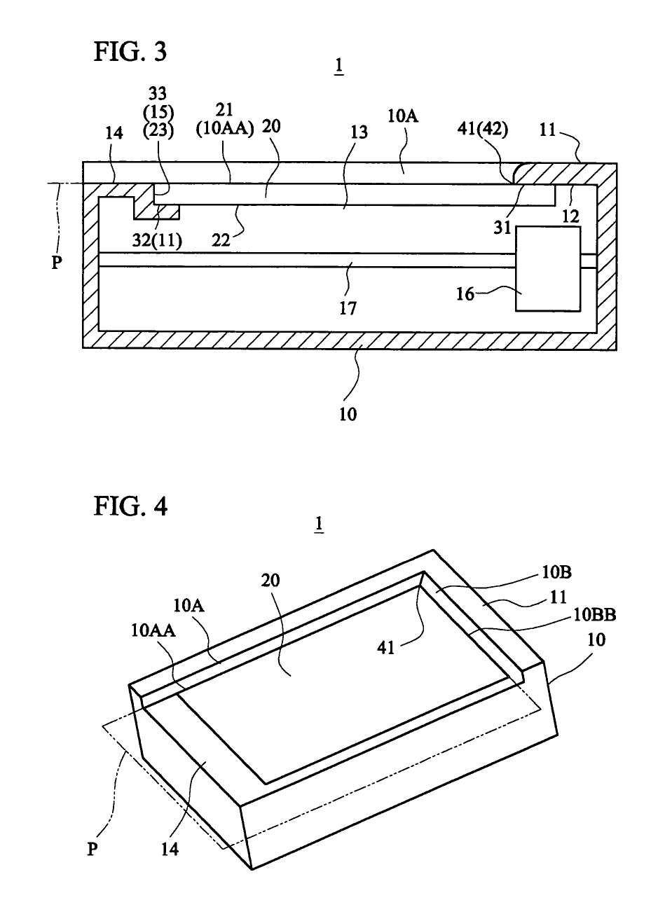

FIG. 2 is a pictorial view showing a scan window assembly according to a first embodiment of the invention. FIG. 3 is a cross-sectional view showing the scan window assembly of FIG. 2. Referring to FIGS. 2 and 3, the scan window assembly 1 (equivalent to a scanner) with an open boundary of this embodiment includes a hollow housing 10, a transparent platen 20, three positioning edges 10AA, 10BB and 10CC, a first positioning corner 41 and a second positioning corner 42. Three sidewalls 10A to 10C of the hollow housing 10 form the open boundary for the transparent platen 20, and provide the three positioning edges 10AA, 10BB and 10CC for positioning the document placed on the transparent platen 20. It is to be noted that the hollow housing 10 may only form two of the three sidewalls 10A to 10C, and the rest one of the sidewalls 10A to 10C may be formed on an upper cover (not shown) of the scanner. After the upper cover is mounted to the hollow housing 10, a sidewall may be provided to cooperate with the two sidewalls of the hollow housing 10 so as to provide the three positioning edges 10AA, 10BB and 10CC, the first positioning corner 41 and the second positioning corner 42.

The hollow housing 10 has a horizontal external surface 11, a horizontal internal surface 12, and an opening 13 penetrating through the hollow housing 10 from the horizontal external surface 11 to the horizontal internal surface 12. The opening 13 is usually rectangular, but is not limited thereto. An optical module 16 and a guiding rod 17 are disposed in the hollow housing 10. The optical module 16 can be moved along the guiding rod 17 so as to acquire an image of the document P. The hollow housing 10 further has a document supporting surface 14 for supporting the document P placed thereon. The document supporting surface 14 is flush with a horizontal top surface 21 of the transparent platen 20, and the document supporting surface 14 is a portion of the horizontal external surface 11. Therefore, the large-format document P also may be placed on the transparent platen 20 with a uniform depth of focus and the scanned quality is thus free from being influenced. In this embodiment, the document supporting surface 14 is rectangular.

The transparent platen 20 has the horizontal top surface 21 and a horizontal bottom surface 22. The hollow housing 10 contacts the transparent platen 20 at a plurality of interfaces to seal the opening 13 of the hollow housing 10. It is to be noted that the above-mentioned horizontal external surface 11, horizontal internal surface 12, horizontal top surface 21 and horizontal bottom surface 22 need not to be in a completely horizontal state, and may be slightly tilted according to the design requirement without influencing the function of the invention. These interfaces include a first interface 31, a second interface 32, and a third interface 33.

The first interface 31 is formed by the horizontal internal surface 12 of the hollow housing 10 and the horizontal top surface 21 of the transparent platen 20 contacting the horizontal internal surface 12. The second interface 32 is formed by the horizontal external surface 11 of the hollow housing 10 and the horizontal bottom surface 22 of the transparent platen 20 contacting the horizontal external surface 11. The second interface 32 and the first interface 31 are positioned at different horizontal heights. In this embodiment, a step between the second interface 32 and the first interface 31 is equal to a thickness of the transparent platen 20 in the vertical direction. The third interface 33 is formed by a vertical surface 15 of the hollow housing 10 and a vertical side surface 23 of the transparent platen 20 contacting the vertical surface 15. It is to be noted that the function of the invention can be achieved without the third interface 33.

The first positioning corner 41 and the second positioning corner 42, which are formed by the transparent platen 20 and the opening 13 of the hollow housing 10, are for positioning the document P placed on the transparent platen 20. In this embodiment, a corner of the document P may be quickly positioned according to the second positioning corner 42 or the first positioning corner 41.

FIG. 4 is a pictorial view showing a scan window assembly according to a second embodiment of the invention. As shown in FIG. 4, the second embodiment is similar to the first embodiment except that the document supporting surface 14 of the second embodiment is L-shaped and the open boundary of the transparent platen 20 is formed by two sidewalls 10A and 10B of the hollow housing 10.

Therefore, it is possible to allow that the length and width of the document P exceed the length and width of the opening 13. However, the first embodiment only allows that the length of the document P exceeds that of the opening 13.

In this embodiment, the sidewalls 10A and 10B provide two positioning edges 10AA and 10BB for positioning the document placed on the transparent platen 20. It is to be noted that the hollow housing 10 can only form a sidewall 10A or 10B, and the portion corresponding to the sidewall 10B or 10A can be formed on the upper cover (not shown) of the scanner. After the upper cover is mounted to the hollow housing 10, it is possible to provide another sidewall in conjunction with the sidewall of the hollow housing 10 so as to provide two positioning edges 10AA and 10BB and the first positioning corner 41. Thus, only one positioning edge has to be formed on the hollow housing 10.

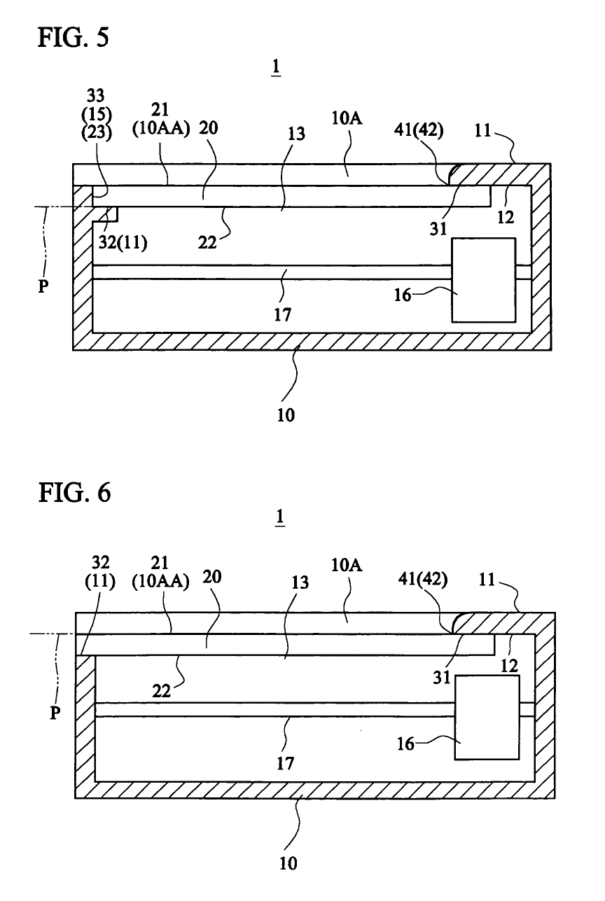

FIG. 5 is a cross-sectional view showing a scan window assembly according to a third embodiment of the invention. As shown in FIG. 5, the third embodiment is similar to the first embodiment except that the third embodiment can achieve the objects of the invention without the document supporting surface 14 provided by the hollow housing 10. FIG. 6 is a cross-sectional view showing a scan window assembly according to a fourth embodiment of the invention. As shown in FIG. 6, the fourth embodiment is similar to the first embodiment except that the fourth embodiment can achieve the objects of the invention without the document supporting surface 14 provided by the hollow housing 10, and also without the third interface 33 formed by the vertical surface 15 of the hollow housing 10 contacting the vertical side surface 23 of the transparent platen 20.

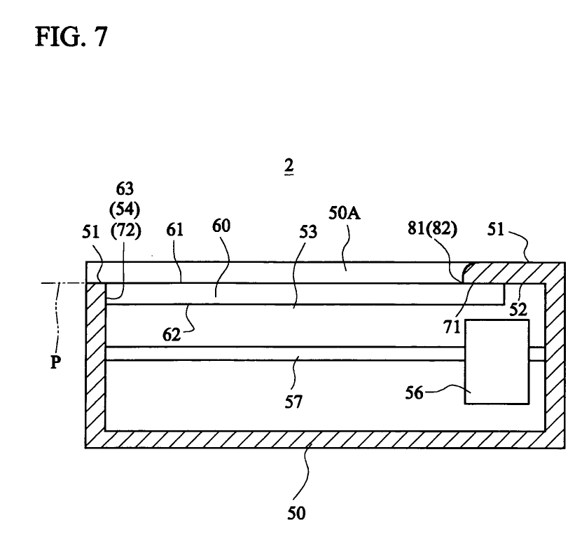

FIG. 7 is a cross-sectional view showing a scan window assembly according to a fifth embodiment of the invention. Referring to FIG. 7, the scan window assembly 2 of this embodiment includes a hollow housing 50, a transparent platen 60, a first positioning corner 81 and a second positioning corner 82. An optical module 56 and a guiding rod 57 are mounted in the hollow housing 50, and the optical module 56 can be moved along the guiding rod 57 in order to acquire the image of the document P. The hollow housing 50 has a horizontal external surface 51, a horizontal internal surface 52, an opening 53 penetrating through the housing 50 from the horizontal external surface 51 to the horizontal internal surface 52, and a vertical surface 54. The open boundary of the transparent platen 60 is formed by three sidewalls of the hollow housing 50. In this drawing, however, only the sidewall 50A is illustrated.

The transparent platen 60 has a horizontal top surface 61, a horizontal bottom surface 62 and a vertical side surface 63. The hollow housing 50 contacts the transparent platen 60 at a plurality of interfaces in order to seal the opening 53 of the hollow housing 50. These interfaces include a first interface 71 and a second interface 72. The first interface 71 is formed by the horizontal internal surface 52 of the hollow housing 50 and the horizontal top surface 61 of the transparent platen 60 contacting the horizontal internal surface 52. The second interface 72 is formed by the vertical surface 54 of the hollow housing 50 and the vertical side surface 63 of the transparent platen 60 contacting the vertical surface 54. The horizontal top surface 61 of the transparent platen 60 is flush with the horizontal external surface 51 adjacent to the vertical surface 54.

The first positioning corner 81 and the second positioning corner 82, which are formed by the transparent platen 60 and the opening 53 of the hollow housing 50, are used for positioning the document P placed on the transparent platen 60. In this embodiment, one corner of the document P may be quickly positioned according to the second positioning corner 82 or the first positioning corner 81.

It is to be noted that an angle between the document supporting surface 14 and the transparent platen 20 in FIGS. 2 to 4 is 180 degrees, and a fully opened book can be supported thereon. The angle between the document supporting surface and the transparent platen in FIGS. 5 to 7 is 90 degrees, and a partially opened book may be supported thereon. In practice, however, it is inconvenient to fully open the book or partially open the book by 90 degrees. Usually, when the book is scanned, it is more convenient that the opened angle between the internal pages of the book ranges from 90 to 180 degrees. Such a supporting manner will be provided in the following embodiments.

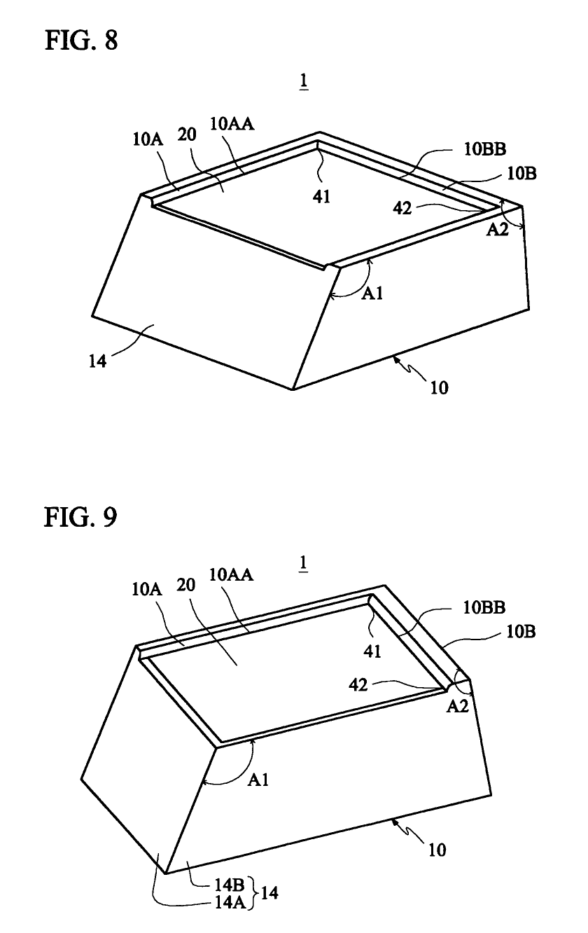

FIGS. 8 to 11 are cross-sectional views showing a scan window assembly according to sixth to ninth embodiments of the invention. As shown in FIG. 8, an angle A1 between the transparent platen 20 and the document supporting surface 14 of the hollow housing 10 in the scan window assembly 1 of this embodiment ranges from 90 to 180 degrees so as to support the partially opened book. As shown in FIG. 9, the document supporting surface 14 of the hollow housing 10 has a first document supporting portion 14A and a second document supporting portion 14B. A first angle A1 between the first document supporting portion 14A and the transparent platen 20 ranges from 90 to 180 degrees so as to support the partially opened book. In addition, a second angle A2 between the second document supporting portion 14B and the transparent platen 20 ranges from 90 to 180 degrees so as to support the partially opened book. Therefore, the book to be scanned may be transversally or longitudinally placed on the scan window assembly.

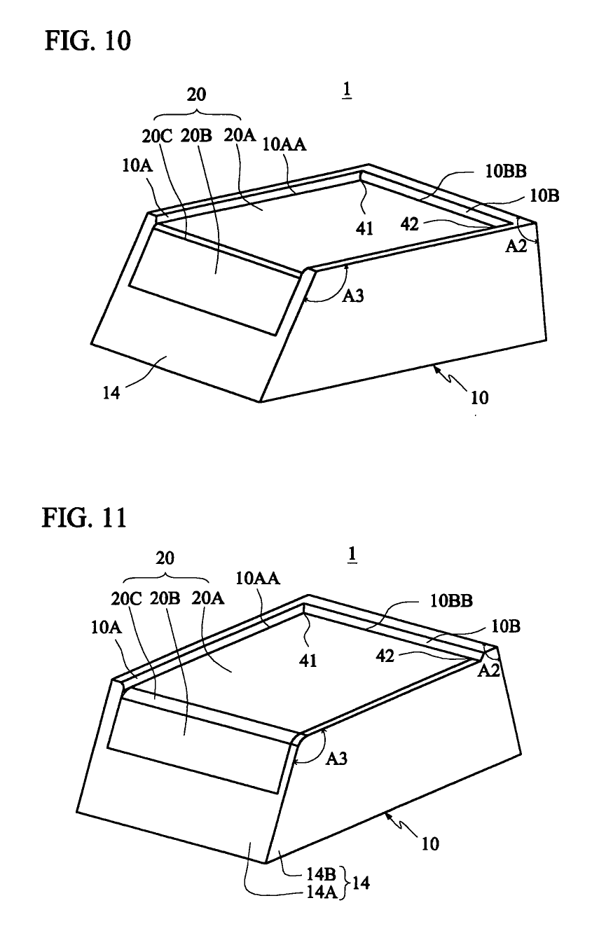

Referring to FIG. 10, the transparent platen 20 of the scan window assembly 1 of this embodiment has a first plate 20A, a second plate 20B, and a bent portion 20C connecting the first plate 20A to the second plate 20B. The first plate 20A, the second plate 20B and the bent portion 20C are integrally formed into a one-piece member, which may be usually shaped when the transparent platen is manufactured. A plate angle A3 between the first plate 20A and the second plate 20B ranges from 90 to 180 degrees so as to support the partially opened book. The bent portion 20C can support the internal binding edge of the book.

Referring to FIG. 11, the hollow housing 10 of the scan window assembly 1 of this embodiment further has a first document supporting portion 14A. The portion 14A and the second plate 20B of the transparent platen 20 are located at the same plane in order to assist the second plate 20B to support the book. Furthermore, the hollow housing 10 further has a second document supporting portion 14B. The second angle A2 between the second document supporting portion 14B and the transparent platen 20 ranges from 90 to 180 degrees so as to support the partially opened book. Therefore, the book to be scanned may be transversally or longitudinally placed on the scan window assembly.

It is to be noted that the features of the sixth to ninth embodiments also may be incorporated into the fifth embodiment.

Consequently, the scan window assembly of the invention has the following advantages.

1. Because the boundary for the transparent platen is an open boundary, a large format document may be carried on the transparent platen with the uniform depth of focus so that the scan effects of the large format document are free from being influenced.

2. Because the boundary for the transparent platen is an open boundary, the document may be easily placed on the transparent platen. When the document is to be taken out, it is also possible to push the document out of the open boundary, and the document may be conveniently taken away.

3. Because the scan window assembly has one positioning corner, the document may be quickly positioned according to this positioning corner. Thus, it is possible to prevent the document from being placed out of the effective scan region of the transparent platen owing to the user's inadvertence.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A scan window assembly with an open boundary, the scan window assembly comprising:
a hollow housing having an external surface, an internal surface, and an opening penetrating through the hollow housing from the external surface to the internal surface;
a transparent platen having a top surface and a bottom surface, wherein the hollow housing contacts the transparent platen at a plurality of interfaces to seal the opening of the hollow housing, and the interfaces comprises:
a first interface formed by the internal surface of the hollow housing and the top surface of the transparent platen contacting the internal surface; and
a second interface formed by the external surface of the hollow housing and the bottom surface of the transparent platen contacting the external surface, wherein the second interface and the first interface are positioned at different horizontal heights; and
a positioning edge, which is formed by the transparent platen and the hollow housing, for positioning a document placed on the transparent platen.

2. The scan window assembly according to claim 1, further comprising a first positioning corner, which is formed by the transparent platen and the opening of the hollow housing, for positioning the document placed on the transparent platen.

3. The scan window assembly according to claim 1, wherein the hollow housing further has a document supporting surface for supporting the document placed thereon, the document supporting surface is flush with the top surface of the transparent platen, and the document supporting surface is a portion of the external surface.

4. The scan window assembly according to claim 3, wherein the document supporting surface is rectangular.

5. The scan window assembly according to claim 3, wherein the document supporting surface has an L-shape.

6. The scan window assembly according to claim 2, further comprising a second positioning corner, which is formed by the transparent platen and the opening of the hollow housing, for positioning the document placed on the transparent platen.

7. The scan window assembly according to claim 1, wherein an optical module and a guiding rod are disposed on the hollow housing, and the optical module is movable along the guiding rod to acquire an image of the document.

8. The scan window assembly according to claim 1, wherein the interfaces further comprise:
a third interface formed by a vertical surface of the hollow housing and a vertical side surface of the transparent platen contacting the vertical surface.

9. The scan window assembly according to claim 1, wherein the hollow housing further has a document supporting surface, and an angle between the document supporting surface and the transparent platen ranges from 90 to 180 degrees so as to support a book that is partially opened.

10. The scan window assembly according to claim 1, wherein the hollow housing further has a document supporting surface, which has a first document supporting portion and a second document supporting portion, and a first angle between the first document supporting portion and the transparent platen ranges from 90 to 180 degrees so as to support a book that is partially opened.

11. The scan window assembly according to claim 10, wherein a second angle between the second document supporting portion and the transparent platen ranges from 90 to 180 degrees so as to support the book that is partially opened.

12. The scan window assembly according to claim 1, wherein the transparent platen has a first plate, a second plate, and a bent portion connecting the first plate to the second plate, and a plate angle between the first plate and the second plate ranges from 90 to 180 degrees so as to support a book that is partially opened.

13. The scan window assembly according to claim 12, wherein the hollow housing further has a first document supporting portion, and the first document supporting portion and the second plate of the transparent platen are located on the same plane.

14. The scan window assembly according to claim 13, wherein the hollow housing further has a second document supporting portion, and a second angle between the second document supporting portion and the transparent platen ranges from 90 to 180 degrees so as to support the book that is partially opened.

15. A scan window assembly with an open boundary, the scan window assembly comprising:
a hollow housing having an external surface, an internal surface, an opening penetrating through the hollow housing from the external surface to the internal surface, and a vertical surface;
a transparent platen having a top surface, a bottom surface and a vertical side surface, wherein the hollow housing contacts the transparent platen at a plurality of interfaces to seal the opening of the hollow housing, and the interfaces comprises:
a first interface formed by the internal surface of the hollow housing and the top surface of the transparent platen contacting the internal surface; and
a second interface formed by the vertical surface of the hollow housing and the vertical side surface of the transparent platen contacting the vertical surface, wherein the top surface of the transparent platen is flush with the external surface that is adjacent to the vertical surface; and
a positioning edge, which is formed by the transparent platen and the opening of the hollow housing, for positioning a document placed on the transparent platen.

16. The scan window assembly according to claim 15, further comprising a first positioning corner, which is formed by the transparent platen and the opening of the hollow housing, for positioning the document placed on the transparent platen.

17. The scan window assembly according to claim 16, further comprising a second positioning corner, which is formed by the transparent platen and the opening of the hollow housing, for positioning the document placed on the transparent platen.

18. The scan window assembly according to claim 15, wherein an optical module and a guiding rod are disposed on the hollow housing, and the optical module is movable along the guiding rod to acquire an image of the document.

19. The scan window assembly according to claim 15, wherein the hollow housing further has a document supporting surface, and an angle between the document supporting surface and the transparent platen ranges from 90 to 180 degrees so as to support a book that is partially opened.

20. The scan window assembly according to claim 15, wherein the hollow housing further has a document supporting surface, which has a first document supporting portion and a second document supporting portion, and a first angle between the first document supporting portion and the transparent platen ranges from 90 to 180 degrees so as to support a book that is partially opened.

21. The scan window assembly according to claim 20, wherein a second angle between the second document supporting portion and the transparent platen ranges from 90 to 180 degrees so as to support the book that is partially opened.

22. The scan window assembly according to claim 15, wherein the transparent platen has a first plate, a second plate, and a bent portion connecting the first plate to the second plate, and a plate angle between the first plate and the second plate ranges from 90 to 180 degrees so as to support a book that is partially opened.

23. The scan window assembly according to claim 22, wherein the hollow housing further has a first document supporting portion, and the first document supporting portion and the second plate of the transparent platen are located on the same plane.

24. The scan window assembly according to claim 23, wherein the hollow housing further has a second document supporting portion, and a second angle between the second document supporting portion and the transparent platen ranges from 90 to 180 degrees so as to support the book that is partially opened.
